(19) United States
(12) Patent Application Publication
(10) Pub. No.: US 2014/0100909 A1
(43) Pub. Date: Apr. 10, 2014

(54) SYSTEM AND METHOD FOR TESTING AND VALIDATION

(71) Applicant: Infosys Limited, Bangalore (IN)

(72) Inventor: Gaurish Vijay Hattangadi, Pune (IN)

(73) Assignee: Infosys Limited, Bangalore (IN)

(21) Appl. No.: 14/045,775

(22) Filed: Oct. 3, 2013

(30) Foreign Application Priority Data
Oct. 3, 2012 (IN) 4119/CHE/2012

(51) Int. Cl. G06Q 10/06

(52) U.S. Cl. CPC G06Q 10/06316
USPC 705/7.26

(57) ABSTRACT

A computer-implemented method comprises receiving an initial workflow, wherein the initial workflow corresponds to a validation test and comprises one or more steps, and wherein the result of at least one step depends on one or more essential entities, receiving input identifying one or more objects in a predetermined technology implementation which correspond to the one or more essential entities, and linking the one or more essential entities to the one or more corresponding objects in the predetermined technology implementation to create a customized workflow, such that when the steps in the workflow which depend on the one or more essential entities are executed, the one or more corresponding objects are used to determine the result of the steps. The initial workflow may be received as input from a user and the customized workflow can be executed to determine a result of the validation test for the predetermined technology implementation.

### RELATED APPLICATION DATA

This application claims priority to India Patent Application No. 4119/CHE/2012, filed Oct. 3, 2012, the disclosure of which is hereby incorporated by reference in its entirety.

### FIELD OF THE INVENTION

The invention relates to a system and method for testing and validation.

### BACKGROUND

Validation tests are used in IT implementations, such as Business Process Management (BPM) applications, for a variety of purposes. For example, validation tests can be used during transaction processing to ensure that the transaction data includes all of the relevant parties and that the buyer has sufficient funds to make a purchase. Other examples of validation tests include determining whether a customer has a valid shipping address, whether a message is properly formatted, whether a credit card is blocked, whether an item is out of stock, whether the billing address provided matches the billing address received from a credit card company's records, and many others.

Unfortunately the IT implementation of these processes and business functions tends to vary across organizations. The current state of accepted testing knowledge forces IT vendors to recreate test suites for validation tests across customers even if logical business processes and functions with customers in similar domains is the same. In other words, test suites are recreated discretely for multiple customers within a domain by IT vendors even if logical workflows and functions are the same. This is because different companies utilize different technology implementations, and the business process is intimately tied to the technology implementation.

For example, a certain vendor may want to verify that an address where an item is to be shipped is a valid address. If the particular technology implementation used by that vendor stores address information for customers as part of a consumer data structure, and all of their implementation language and other business processes refer to the consumer data structure when accessing the address, then a validation test which is catered to a technology implementation which stores the address as part of a data structure associated with a shipped item will not be useful for the technology implementation of the vendor, even though the goal of the validation test may also be to determine that the address is a valid address.

### BRIEF DESCRIPTION OF THE DRAWINGS

FIG. 1 is a flowchart of an exemplary method for creating a customized workflow according to the disclosed embodiment.

FIG. 2 is a flowchart illustrating the relationship between a validation test and essential entities.

FIG. 3 is an exemplary workflow which can be used with the methods of the disclosed embodiment.

FIG. 4 is an exemplary user interface used to map essential entities to technology implementation specific objects according to the disclosed embodiment.

FIG. 5 is an exemplary workflow interface that can be used with the methods of the disclosed embodiment and an exemplary user interface used to map essential entities to technology implementation specific objects according to the disclosed embodiment.

FIG. 6 is an exemplary customized workflow generated using the methods of the disclosed embodiment.

FIG. 7 is a flowchart of an exemplary method of executing the customized workflow according to the disclosed embodiment.

FIG. 8 is an exemplary distribution architecture for the different validation services according to the disclosed embodiment.

FIG. 9 shows an exemplary computing environment useful for implementing apparatuses and computer readable media, and performing methods according to the disclosed embodiment.

### DETAILED DESCRIPTION

The inventor has identified a need for a system which would allow IT vendors to separate the problem domain aspects of a validation test from the specific technology implementation of that test, so that validation tests and test cases can be reused across organizations with varying technology implementations.

While methods, apparatuses, and computer-readable media are described herein by way of examples and embodiments, those skilled in the art recognize that methods, apparatuses, and computer-readable media for testing and validation are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

Methods, apparatuses and computer-readable media are described which enable users to isolate the problem domain aspects of a validation test in the form of an initial workflow, and to reuse the initial workflow by customizing it to different technology implementations to create customized workflows which can be used for validation testing in the different technology implementations.

### Receiving Initial Workflow

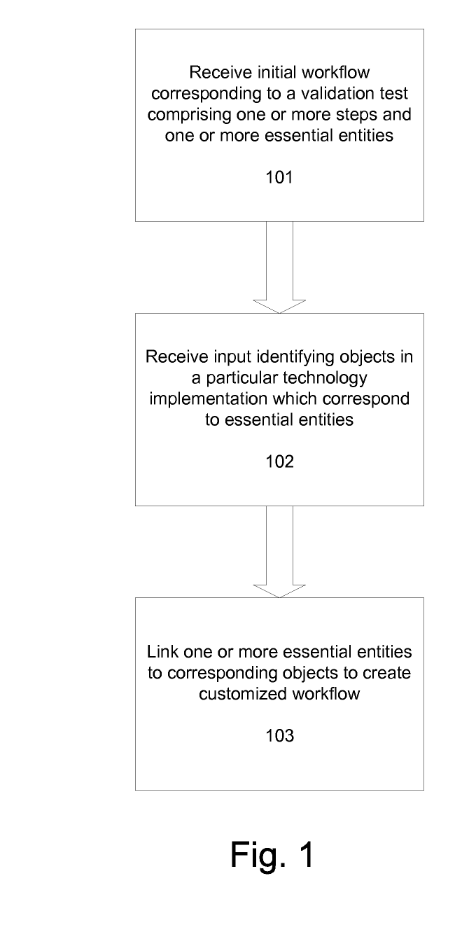

FIG. 1 illustrates an exemplary embodiment of the method for customizing a validation test. In step 101 an initial workflow corresponding to a validation test is received. The validation test can involve message testing, payment and transaction verification, or the testing and validation of any other business process or function. The workflow may be input into a computing device by a user, received from another computing device, or stored on computer readable media, and may be in any format suitable to store workflows. The initial workflow may be created by users or system administrators who are familiar with the problem domain relating to the validation test, referred to as domain experts, who can correctly identify the various steps necessary to reach a decision in a validation test and translate those steps into a workflow. One example of a validation test that could be modeled as a workflow would be determining whether a particular message, such as a transaction authorization message, contains the information required to carry out the transaction.

### Essential Entities

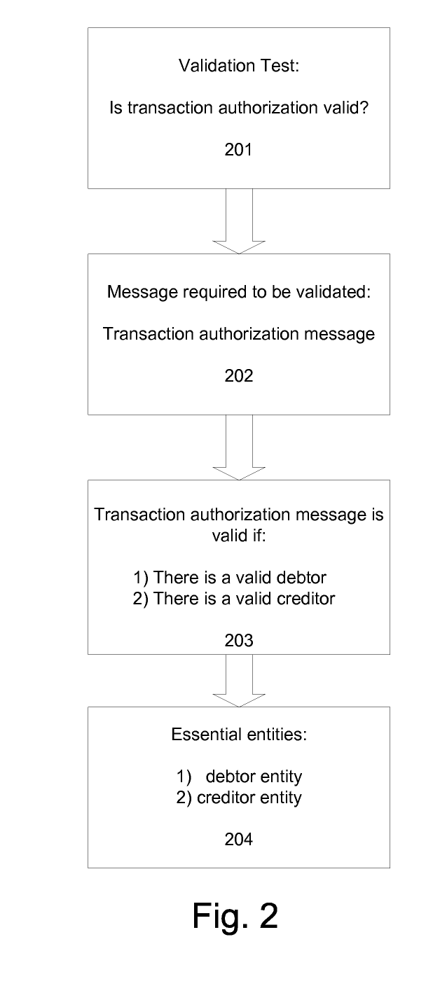

At least some of the steps in a particular workflow will contain one or more essential entities. That is, entities that are necessary to make a determination regarding validity. One example of the relationship between a validation test and essential entities is shown in FIG. 2, using the earlier discussed example where the validation test constitutes determining whether a transaction authorization is valid, 201. As used in this disclosure, entity is meant to encompass all classes of objects, such as constants, variables, classes, portions of classes, or any other data structure which can be used to hold an entity.

In this example, the actual document that is required to be validated is the transaction authorization message, 202. In step 203 the domain expert or other user may determine that in order for the transaction authorization message to be valid, it must contain a valid debtor and a valid creditor. Therefore, the essential entities for this particular validation test would be the debtor entity and the creditor entity. These entities and rules are provided for illustration only, and the actual rules determined to validate any particular document or message can vary depending on the validation test, the problem domain, and the domain expert preferences.

### Structure of Workflow

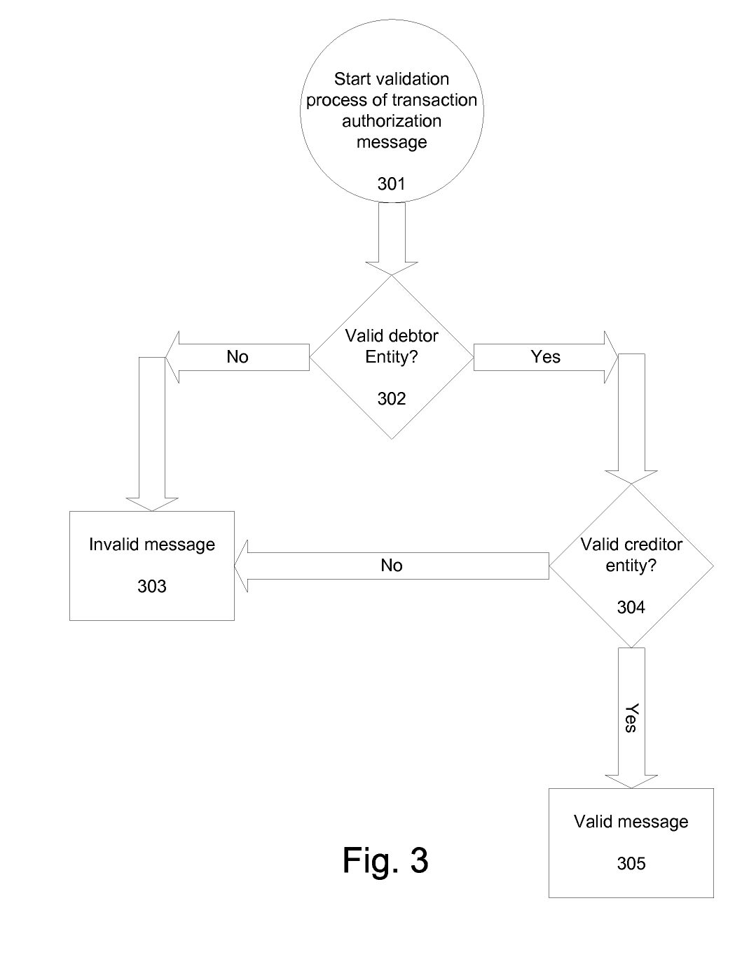

An example workflow generated using the essential entities of FIG. 2 is shown in FIG. 3. After the start of the validation process, 301, a transaction authorization message is checked to determine whether there is a valid value for the debtor entity in step 302. If there is no valid debtor value, then the message is deemed invalid, 303, and the transaction authorization will be denied. If there is a valid debtor value, then the next step is to determine whether there is a valid value for the creditor entity, 304. Once again, if the message contains no valid creditor value, then the message is deemed invalid. However, if the creditor entity contains a valid value, then the message is determined to be valid, 305.

Of course, the workflow shown is just provided as an example, and the actual workflows implemented for different or similar validation rules could vary greatly.

### Receiving Input Identifying Corresponding Objects

Referring back to FIG. 1, in step 102 one or more of the computing devices in the system may receive information indicating which objects in a particular technology implementation correspond to the essential entities in the steps of a workflow. An example of this would be if the essential entity is a consumer entity, and a particular technology implementation refers to consumers as customers, then the object of a “customer” corresponds to the essential consumer entity.

This information may be input by a domain expert, a technology specialist who is familiar with a particular technology implementation, or some other user. Using the workflow of FIG. 3 as an example, the user or domain expert would identify the objects which correspond to the debtor entity and the creditor entity in a specific technology implementation. This may be accomplished via a user interface or series of commands which allow the user to manipulate or interact with the validation workflow steps or validation rules. For example, a domain expert who is customizing the workflow for validating a transaction authorization message, such as in FIG. 3, to a specific technology implementation, could use a graphical user interface to specify which objects in a particular technology implementation the debtor entity and creditor entity correspond to.

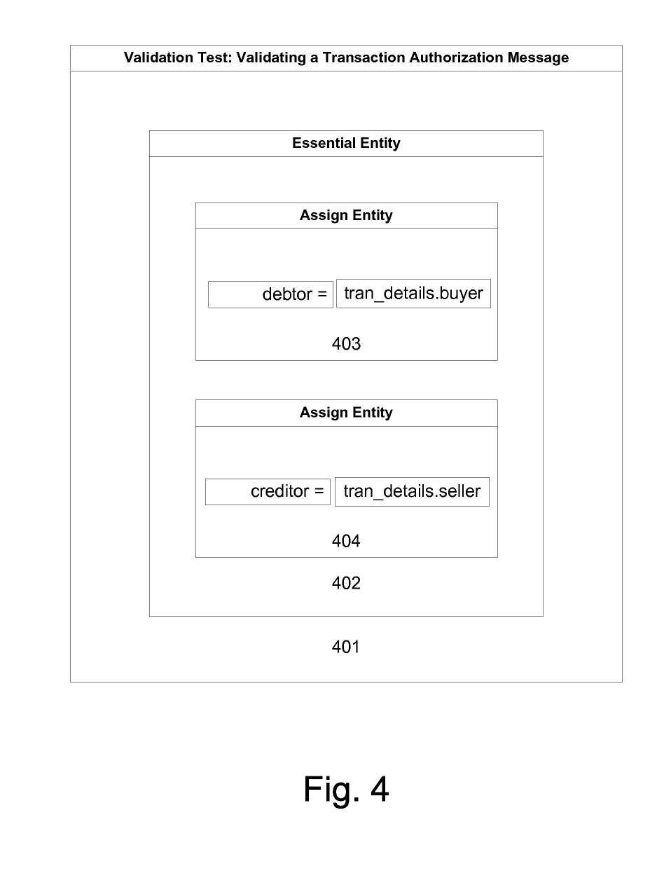

FIG. 4 illustrates a sample graphical user interface that could be used to provide this information. Window 401 represents a general interface for the validation test. Contained within the window could be another window, 402, that presents information concerning the essential entities. Each of these entities can be mapped to their counterpart objects in a specific technology implementation via assignment windows 403 and 404. In the example provided, the debtor entity is assigned to an object called trans_details.buyer and the creditor entity is mapped to trans details.seller, indicating that the values corresponding to a debtor and a creditor can be found in those objects for the specific technology implementation being used. These example values are provided solely to illustrate the operation of the input process and user interface, and are not intended to limit or define the features disclosed herein.

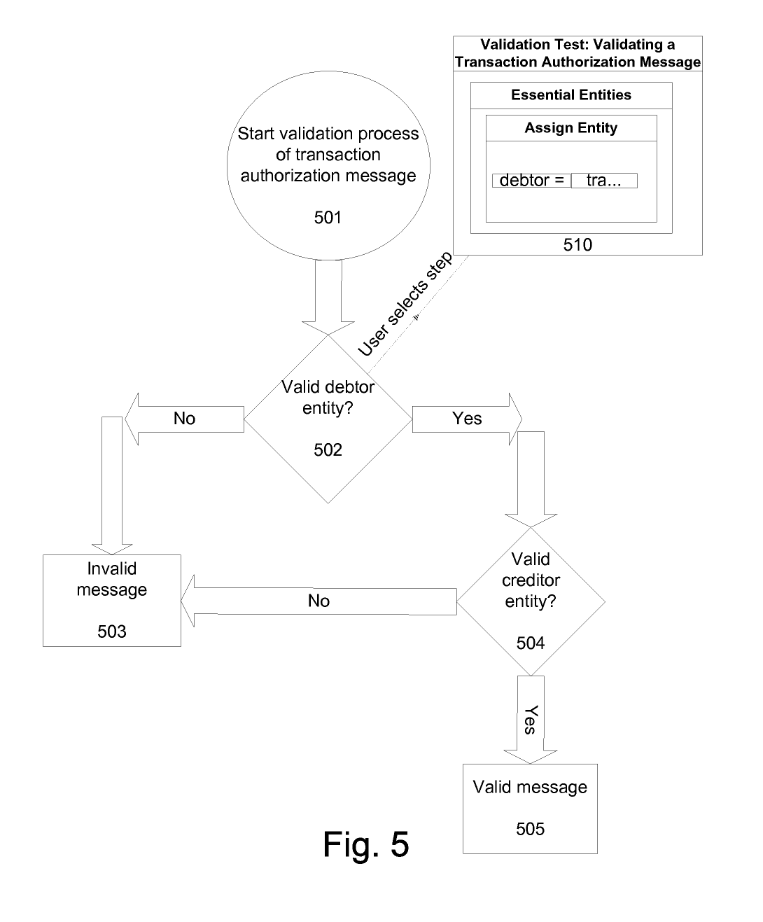

FIG. 5 shows how this input interface could be integrated into a workflow interface which displays a workflow corresponding to a particular validation test. The user could interact with the workflow to input the specific objects which correspond to the essential entities. Steps 501-505 in FIG. 5 show the same workflow from FIG. 3 for determining whether a transaction authorization message is valid. In an exemplary embodiment, the user can click or otherwise select the step corresponding to the essential entity for which they wish to input an object name. FIG. 5 shows the interface, 510, that opens when the user selects step 502, corresponding to the debtor entity. In interface 510 the user can assign the value of the debtor entity to the technology implementation specific object, and the assignment will then be integrated into the workflow. So, for example, if the user elects to assign the debtor entity to trans_details.buyer as shown in FIG. 4, when the workflow executes and reaches step 502, the value of the data corresponding to trans_details.buyer will be checked to determine whether there is a valid debtor entity in the transaction authorization message.

### Linking Essential Entities to Corresponding Objects

Returning once again to FIG. 1, in step 103, the one or more essential entities are linked to the corresponding technology implementation specific objects indicated by the user. The actual mechanism used for the linking can vary, but the linking is done in such a way that when the steps in the workflow are executed and data corresponding to an essential entity is required, data corresponding to the technology implementation specific object which has been assigned to that essential entity is retrieved.

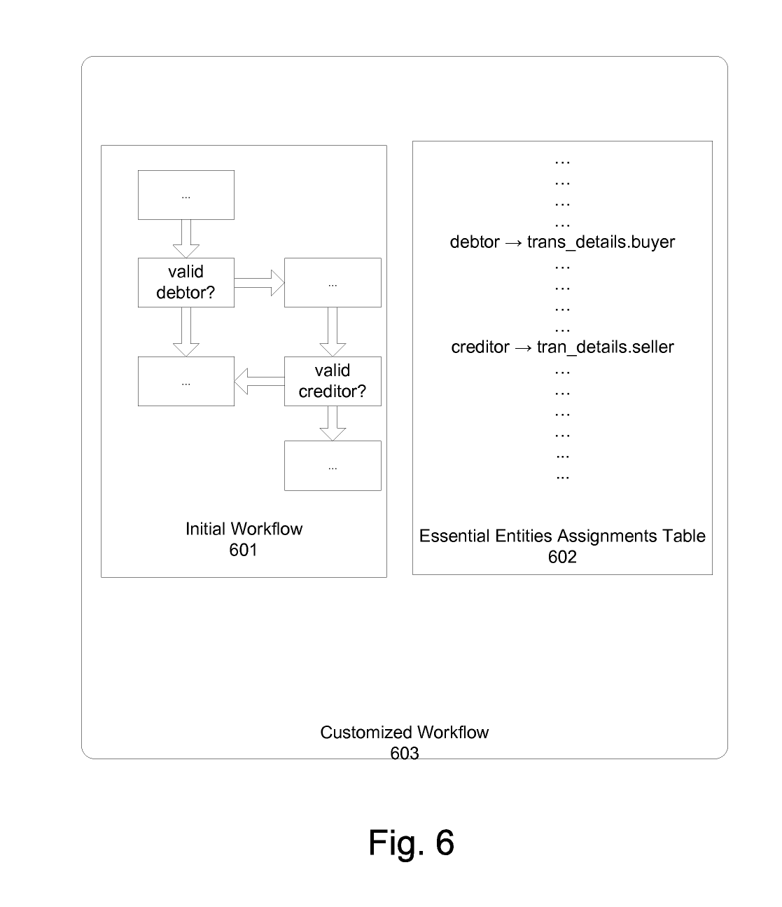

FIG. 6 illustrates a data organization scheme which could be used to store the essential entity linking information. The links between the essential entities in an initial workflow 601 can be stored in an assignments table 602 on tangible computer readable media. Assignments table 602 is presented only to illustrate a data structure that could be used to store linking information, and the actual linking data structure or structures used could vary. For example, each assignment could be stored in an independent data structure, or could be stored as an expression, such as a Microsoft LINQ (Language Integrated Query) expression. Initial workflow 601 and assignment information 602 together can comprise the customized workflow, 603, such that the customized workflow 603 can be executed to perform a validation test for a technology implementation which utilizes the technology implementation specific objects which are linked to in the assignments table, 602.

### Execution of Customized Workflow

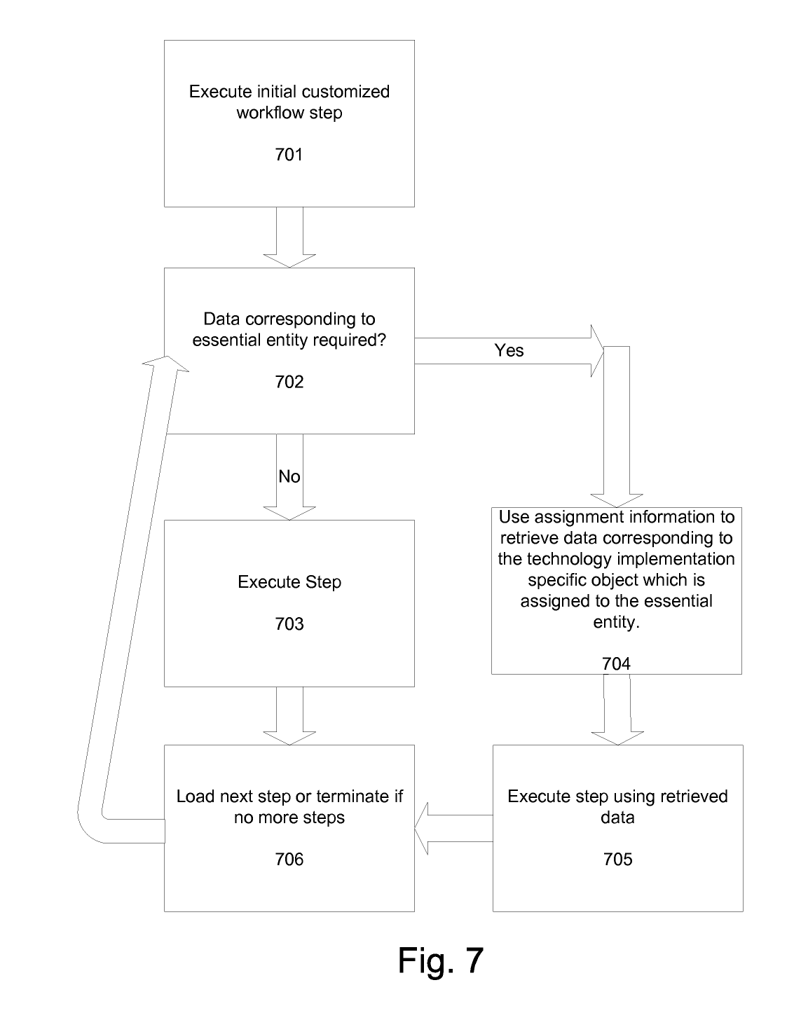

FIG. 7 is a flowchart of the execution process of a customized workflow according to the exemplary embodiment. For the sake of clarity, the steps in the flowchart of FIG. 7 will be referred to as stages, and the steps in the customized workflow will be referred to as steps. Execution begins at the initial step of the customized workflow, stage 701. As the step is executed, the one or more computing devices which are executing the workflow step determine whether data corresponding to an essential entity is required at stage 702. Using our earlier example, one of the computing devices executing the workflow may find that data corresponding to the essential debtor entity is required to make a determination at a particular step. If data corresponding to an essential entity is not required, then the step is executed at stage 703, and at stage 706 the next step is loaded and the process is repeated, or the workflow terminates if there are no more steps. If data corresponding to an essential entity is required, then the data can be retrieved at stage 704 from a document which utilizes a particular technology implementation by using the assignment information to retrieve data corresponding to the technology implementation specific object which has been linked or assigned to the essential entity. For example, if the essential debtor entity is required, and the assignment or linking structure indicates that the data corresponding to a debtor is referred to as trans_details.buyer in the technology implementation, then the data value corresponding to trans_details.buyer is retrieved from the document. This data is then used to execute the customized workflow step at stage 705, and the customized workflow proceeds to the next appropriate step and repeats the process or terminates if there are no more steps at stage 706. At the conclusion of the all the steps in the customized workflow, a validity determination can be returned or output.

### Distribution Architecture

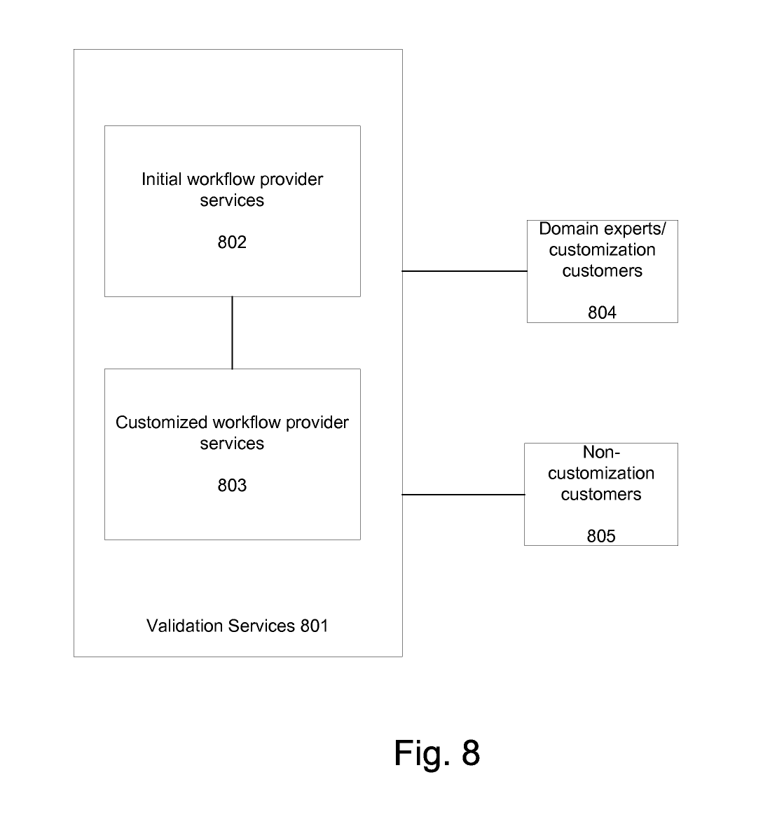

FIG. 8 illustrates an exemplary distribution architecture for the different validation services disclosed herein. The validation services 801 include initial workflow provider services 802, which can provide initial workflows for validating entities in a variety of different problem domains, and customized workflow provider services 803, which can provide customized test suites and test cases for different problem domains directed to specific technology implementations. The validation services provider, 801, can be any kind of computing environment such as a farm of networked servers, a clustered server environment, or a cloud network of computing devices.

Domain experts and other customers who wish to customize initial workflows for a specific technology implementation, 804, may download or otherwise access the initial workflows in a requested problem domain. Additionally, the same customers, 804, may access a customized test suite and further modify it to suit their specific technology implementation. These customers, 804, could download or otherwise obtain a client software package which would allow them to utilize the applications and interfaces discussed earlier to customize the initial workflow to their implementation specific details. So, for example, if a particular user's technology implementation does not conform to industry standards and a customized workflow for that technology implementation is not available, the user could download the initial workflow for that particular validation test and utilize customization software to create a customized workflow for their own technology implementation. The user could also use the initial workflow to create a plurality of different customized workflows. In this way, a workflow corresponding to a specific validation test can be adapted to multiple different technology implementations without requiring the entire validation process to be recreated each time.

Other customers, 805, may download or access the preconfigured customized test suites or test cases for their specific technology implementation without needing any additional software or customization. For example, users that utilize industry standards could request or download a customized test suite which corresponds to industry standards and begin using it without any additional customization required. Users could also upload or transmit messages which they would like to validate to the validation services environment, 801, and receive the results of the validation process in return.

All validation services could have an associated cost to be paid by customers. The services could be implemented using a testing-as-a-service model where each validation process has an associated price. Alternatively, the validation services could be based on a subscriber model. There are many ways to implement the payment process, and the methods disclosed herein are not intended to limit the possible variations or features.

### Computing Environment

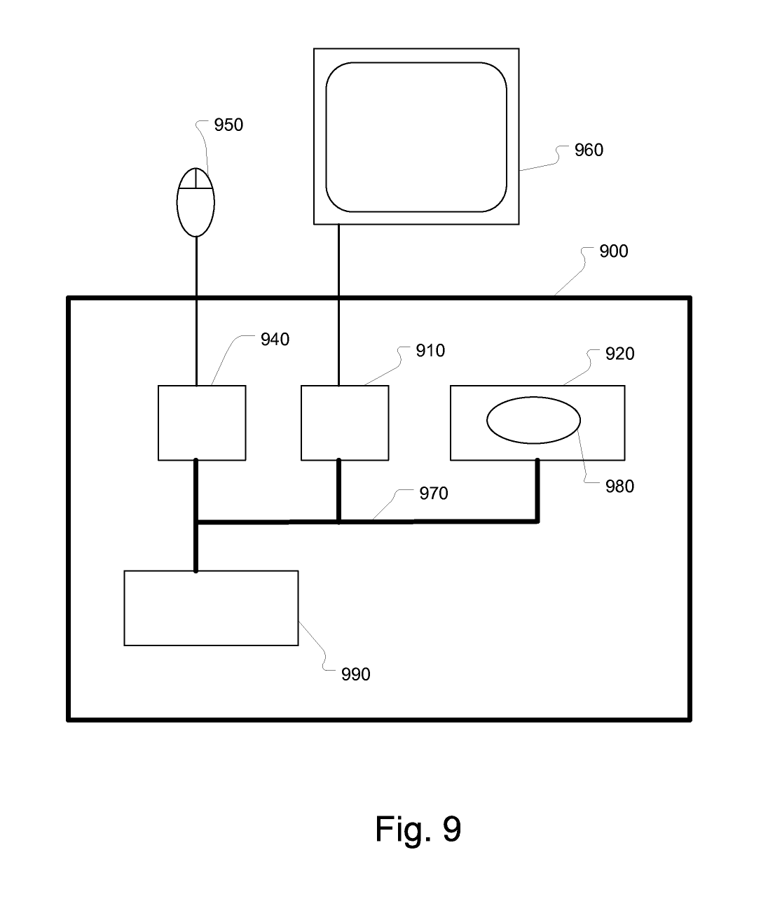

One or more of the above-described techniques can be implemented in or involve one or more computer systems. FIG. 9 illustrates a generalized example of a computing environment 900. The computing environment 900 is not intended to suggest any limitation as to scope of use or functionality of described embodiments.

With reference to FIG. 9, the computing environment 900 includes at least one processing unit 910 and memory 920. The processing unit 910 executes computer-executable instructions and may be a real or a virtual processor. In a multi-processing system, multiple processing units execute computer-executable instructions to increase processing power. The memory 920 may be volatile memory (e.g., registers, cache, RAM), non-volatile memory (e.g., ROM, EEPROM, flash memory, etc.), or some combination of the two. In some embodiments, the memory 920 stores software 980 implementing described techniques.

A computing environment may have additional features. For example, the computing environment 900 includes storage 940, one or more input devices 950, one or more output devices 960, and one or more communication connections 990. An interconnection mechanism 970, such as a bus, controller, or network interconnects the components of the computing environment 900. Typically, operating system software (not shown) provides an operating environment for other software executing in the computing environment 900, and coordinates activities of the components of the computing environment 900.

The storage 940 may be removable or non-removable, and includes magnetic disks, magnetic tapes or cassettes, CD-ROMs, CD-RWs, DVDs, or any other medium which can be used to store information and which can be accessed within the computing environment 900. In some embodiments, the storage 940 stores instructions for the software 980.

The input device(s) 950 may be a touch input device such as a keyboard, mouse, pen, trackball, touch screen, or game controller, a voice input device, a scanning device, a digital camera, or another device that provides input to the computing environment 900. The output device(s) 960 may be a display, printer, speaker, or another device that provides output from the computing environment 900.

The communication connection(s) 990 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 900, computer-readable media include memory 920, storage 940, communication media, and combinations of any of the above.

Of course, FIG. 9 illustrates computing environment 900, display device 960 , and input device 950 as separate devices for ease of identification only. Computing environment 900, display device 960, and input device 950 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 900 may be one or more servers, for example a farm of networked servers, a clustered server environment, or a cloud network of computing devices.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A computer-implemented method of customizing a validation test by one or more computing devices, comprising:
receiving, by at least one of the one or more computing devices, an initial workflow, wherein the initial workflow corresponds to a validation test and comprises one or more steps, and wherein the result of at least one step depends on one or more essential entities;
receiving, by at least one of the one or more computing devices, input identifying one or more objects in a predetermined technology implementation which correspond to the one or more essential entities; and
linking, by at least one of the one or more computing devices, the one or more essential entities to the one or more corresponding objects in the predetermined technology implementation to create a customized workflow, such that when the one or more steps in the customized workflow which depend on the one or more essential entities are executed, the one or more corresponding objects are used to determine the result of the one or more steps.

2. The computer-implemented method of claim 1, wherein the initial workflow is received as input from a user.

3. The computer-implemented method of claim 1, further comprising executing, by at least one of the one or more computing devices, one or more of the steps in the customized workflow to determine a result of the validation test for the predetermined technology implementation.

4. The computer-implemented method of claim 1, further comprising transmitting, by at least one of the one or more computing devices, the initial workflow to one or more users.

5. The computer-implemented method of claim 1, further comprising transmitting, by at least one of the one or more computing devices, the customized workflow to one or more users.

6. The computer-implemented method of claim 1, further comprising:
receiving, by at least one of the one or more computing devices, input identifying one or more second objects in a second predetermined technology implementation which correspond to the one or more essential entities; and
linking, by at least one of the one or more computing devices, the one or more essential entities to the one or more corresponding second objects in the second predetermined technology implementation to create a second customized workflow, such that when the one or more steps in the second customized workflow which depend on the one or more essential entities are executed, the one or more corresponding second objects are used to determine the result of the one or more steps.

7. An apparatus for customizing a validation test by one or more computing devices, the apparatus comprising:
one or more processors; and
one or more memories operatively coupled to at least one of the one or more processors and having instructions stored thereon that, when executed by at least one of the one or more processors, cause at least one of the one or more processors to:
receive an initial workflow, wherein the initial workflow corresponds to a validation test and comprises one or more steps, and wherein the result of at least one step depends on one or more essential entities;
receive input identifying one or more objects in a predetermined technology implementation which correspond to the one or more essential entities; and
link the one or more essential entities to the one or more corresponding objects in the predetermined technology implementation to create a customized workflow, such that when the one or more steps in the customized workflow which depend on the one or more essential entities are executed, the one or more corresponding objects are used to determine the result of the one or more steps.

8. The apparatus of claim 7, wherein the initial workflow is received as input from a user.

9. The apparatus of claim 7, wherein at least one of the one or more memories has further instructions stored thereon that, when executed by at least one of the one or more processors, cause at least one of the one or more processors to execute one or more of the steps in the customized workflow to determine a result of the validation test for the predetermined technology implementation.

10. The apparatus of claim 7, wherein at least one of the one or more memories has further instructions stored thereon that, when executed by at least one of the one or more processors, cause at least one of the one or more processors to transmit the initial workflow to one or more users.

11. The apparatus of claim 7, wherein at least one of the one or more memories has further instructions stored thereon that, when executed by at least one of the one or more processors, cause at least one of the one or more processors to transmit the customized workflow to one or more users.

12. The apparatus of claim 7, wherein at least one of the one or more memories has further instructions stored thereon that, when executed by at least one of the one or more processors, cause at least one of the one or more processors to:
receive input identifying one or more second objects in a second predetermined technology implementation which correspond to the one or more essential entities; and
link the one or more essential entities to the one or more corresponding second objects in the second predetermined technology implementation to create a second customized workflow, such that when the one or more steps in the second customized workflow which depend on the one or more essential entities are executed, the one or more corresponding second objects are used to determine the result of the one or more steps.

13. At least one non-transitory computer-readable medium storing computer-readable instructions for customizing a validation test by one or more computing devices that, when executed by one or more computing devices, cause at least one of the one or more computing devices to:
receive an initial workflow, wherein the initial workflow corresponds to a validation test and comprises one or more steps, and wherein the result of at least one step depends on one or more essential entities;
receive input identifying one or more objects in a predetermined technology implementation which correspond to the one or more essential entities; and
link the one or more essential entities to the one or more corresponding objects in the predetermined technology implementation to create a customized workflow, such that when the one or more steps in the customized workflow which depend on the one or more essential entities are executed, the one or more corresponding objects are used to determine the result of the one or more steps.

14. The at least one non-transitory computer-readable medium of claim 13, wherein the initial workflow is received as input from a user.

15. The at least one non-transitory computer-readable medium of claim 13, further storing computer-readable instructions that, when executed by at least one of the one or more computing devices, cause at least one of the one or more computing devices to execute one or more of the steps in the customized workflow to determine a result of the validation test for the predetermined technology implementation.

16. The at least one non-transitory computer-readable medium of claim 13, further storing computer-readable instructions that, when executed by at least one of the one or more computing devices, cause at least one of the one or more computing devices to transmit the initial workflow to one or more users.

17. The at least one non-transitory computer-readable medium of claim 13, further storing computer-readable instructions that, when executed by at least one of the one or more computing devices, cause at least one of the one or more computing devices to transmit the customized workflow to one or more users.

18. The at least one non-transitory computer-readable medium of claim 13, further storing computer-readable instructions that, when executed by at least one of the one or more computing devices, cause at least one of the one or more computing devices to:
receive input identifying one or more second objects in a second predetermined technology implementation which correspond to the one or more essential entities; and
link the one or more essential entities to the one or more corresponding second objects in the second predetermined technology implementation to create a second customized workflow, such that when the one or more steps in the second customized workflow which depend on the one or more essential entities are executed, the one or more corresponding second objects are used to determine the result of the one or more steps.
